(19) United States
(12) Patent Application Publication
(10) Pub. No.: US 2026/0312464 A1
(43) Pub. Date: Oct. 8, 2026

(54) SPRAY RING FOR AN ELECTRIC MACHINE FOR COOLING STATOR WINDINGS, AND ELECTRIC MACHINE

(71) Applicant: AUDI AG, Ingolstadt (DE)

(72) Inventor: Robert POIDA, Ingolstadt (DE)

(21) Appl. No.: 19/464,366

(22) Filed: Jan. 29, 2026

(30) Foreign Application Priority Data
Jan. 30, 2025 (DE) 102025103374.9

(51) Int. Cl. H02K 9/19

(52) U.S. Cl. CPC H02K 9/19

(57) ABSTRACT

A spray ring for an electric machine is provided, which includes a fluid-tight spray body with a cavity, into which a cooling medium for cooling stator windings of the electric machine can be introduced via a cooling medium inlet formed on the spray body and can be discharged from the spray body via spray openings formed on the spray body, wherein the spray body is formed in an arcuate manner about a body center axis and has a first free end and a second free end which are spaced apart from one another in a circumferential direction of the arcuate spray body, wherein the spray body is elastically deformable in the circumferential direction. An electric machine with such a spray ring is also provided.

### BACKGROUND

### Technical Field

The present disclosure relates to a spray ring for an electric machine for cooling stator windings of the electric machine. The present disclosure also relates to an electric machine with such a spray ring.

### Description of the Related Art

Spray rings with nozzle openings for spraying a coolant onto stator windings of an electric machine are generally known. The spray rings can be sealed along their entire circumference against a stator housing in which the stator windings are arranged. The installation of such spray rings is complex. In addition, tightness must be ensured for a large sealing surface, which in turn places increased demands on a correspondingly large seal.

Spray rings with a self-contained cavity for holding and distributing a cooling medium are known, for example, from CN 218829280 U and EP 4 318 883 A1.

### BRIEF SUMMARY

Against this background, the present disclosure is directed to a spray ring for an electric machine which has a compact design and may also be assembled more easily. Further, the present disclosure is also directed to an electric machine with such a spray ring.

An embodiment of the present disclosure is a spray ring for an electric machine (e.g., an electric motor or a generator) which has a fluid-tight spray body with a cavity. A cooling medium (e.g., oil, air or similar) for cooling the stator windings of the electric machine may be introduced into the cavity via a cooling medium inlet formed on the spray body. The cooling medium may be discharged from the spray body via spray openings (e.g., spray nozzles) formed on the spray body. As the spray body is fluid-tight, the cooling medium may only enter or leave the cavity via the cooling medium inlet and the spray openings. In other words, the spray body encloses the cavity in a fluid-tight manner.

Furthermore, the spray body may be formed in an arcuate manner about a body center axis. The arcuate spray body may also have a first free end and a second free end which are spaced apart from one another in a circumferential direction of the arcuate spray body. In addition, the spray body may be elastically deformable in the circumferential direction.

For the purposes of the disclosure, the body center axis is to be understood as an axis of symmetry or rotation of the spray body.

The first and second free ends spaced apart from one another in the circumferential direction mean that the arcuate spray body is not circumferentially closed. The spacing of the first and second free ends with respect to the circumferential direction and the elastic deformability make it possible to temporarily bend the spray body in its circumferential direction and thus temporarily reduce its diameter. In this way, the spray ring may be installed more easily in a stator housing of the electric machine, e.g., inserted from the inside into a groove introduced on the inside of a stator housing. After installation, a restoring force of the elastically deformable spray body ensures that the spray ring may be securely fastened to the stator housing. Special fastening elements may be dispensed with. The spray ring has an overall compact design.

In addition, the fluid-tight spray body only needs to be sealed at its cooling medium inlet against a transfer point for the cooling medium on the machine side. An O-ring may be used for this purpose, for example. The sealing surface may be limited to a section of, for example, an outer circumferential surface of the cooling medium inlet, the fluid-tight sealing of which may be reliably ensured.

In an advantageous embodiment, the cooling medium inlet may be configured as an inlet nozzle, which has a longitudinal nozzle axis that extends substantially parallel to the body axis of the spray body. The inlet nozzle may be substantially hollow-cylindrical in shape, although other geometries of the inlet nozzle are not excluded. However, the hollow cylindrical inlet nozzle is a particularly advantageous embodiment, as it may be easily and reliably sealed with an O-ring against a transfer point of the cooling medium on the machine side. In addition, the spray body may be fixed via the inlet nozzle both in its circumferential direction and in a radial direction, for example on a stator housing of the electric machine, so that the inlet nozzle simultaneously provides the function of a locking element without having to provide one itself.

Other advantageous embodiments of the spray ring provide for the coolant inlet to be formed at the first free end. While the curved section of the spray body extending between the first and second ends may, for example, be held solely in a groove provided on the housing side of a stator housing, the first free end may be fixed additionally via the inlet nozzle at the machine-side transfer point of the cooling medium. This prevents the spray body from unintentionally deforming elastically, in particular twisting and/or bending, in the region of the first free end due to dynamic forces occurring during operation of the electric machine. This further improves the tight fit of the spray body, for example, on a stator housing of the electric machine.

In another advantageous embodiment, a locking pin may be formed at the second free end, which has a longitudinal pin axis that extends substantially parallel to the body axis of the spray body. In this way, the second free end of the spray body may be fixed to a stator housing of the electric machine, for example, which reliably prevents the spray body from unintentionally deforming elastically, in particular twisting and/or bending, in the region of the second free end due to dynamic forces occurring during operation of the electric machine. The locking pin may be formed in a cylindrical shape, for example. Geometries of the locking pin that deviate from the cylindrical shape are also conceivable.

In another advantageous embodiment, the spray body may be formed from an elastically deformable plastic material. In addition to being easy to manufacture, this embodiment of the spray ring is also lightweight.

In another embodiment, the spray body may have a single cooling medium inlet, which further simplifies the design and reduces the weight even more.

Another embodiment of the disclosure is an electric machine (e.g., an electric motor or a generator) having stator windings arranged in a stator housing, which windings form winding heads in an axial end section of the stator housing, wherein a spray ring for spraying a cooling medium onto the stator windings, in particular onto the winding heads, may be arranged in the axial end section in order to cool them during operation of the electric machine, and the spray ring may be formed according to any of the embodiments disclosed herein.

It is to be understood that with regard to machine-related definitions of terms and the effects and advantages of machine-related features, it can be fully relied upon the disclosure of analogous definitions, effects and advantages of the spray ring according to the disclosure, and vice versa. Repetitive discussion of analogous features, their effects, and their advantages can be omitted in favor of a more compact description, without such omissions being interpreted as a limitation for any of the disclosed subject matter of the disclosure.

In an advantageous embodiment of the electric machine, the stator housing may have a groove extending along the inside of the housing in which the spray ring is held. A secure fit of the spray ring in the groove may be ensured simply due to a restoring force that is effective after assembly, during which the spray body may be elastically deformed in the sense of a reduction in its diameter.

Further advantageous embodiments provide that the cooling medium inlet of the spray body may be sealed against a transfer point of the cooling medium in the stator housing with an O-ring, in particular a single O-ring. The spray body may be inherently liquid-tight and may be sealed only with the O-ring in the stator housing at the machine-side transfer point of the cooling medium.

### BRIEF DESCRIPTION OF THE SEVERAL VIEWS OF THE DRAWINGS

FIG. 1 shows a perspective view of a spray ring according to one embodiment of the disclosure.

FIG. 2 shows a longitudinal sectional view of a part of an electric machine according to one embodiment of the disclosure.

### DETAILED DESCRIPTION

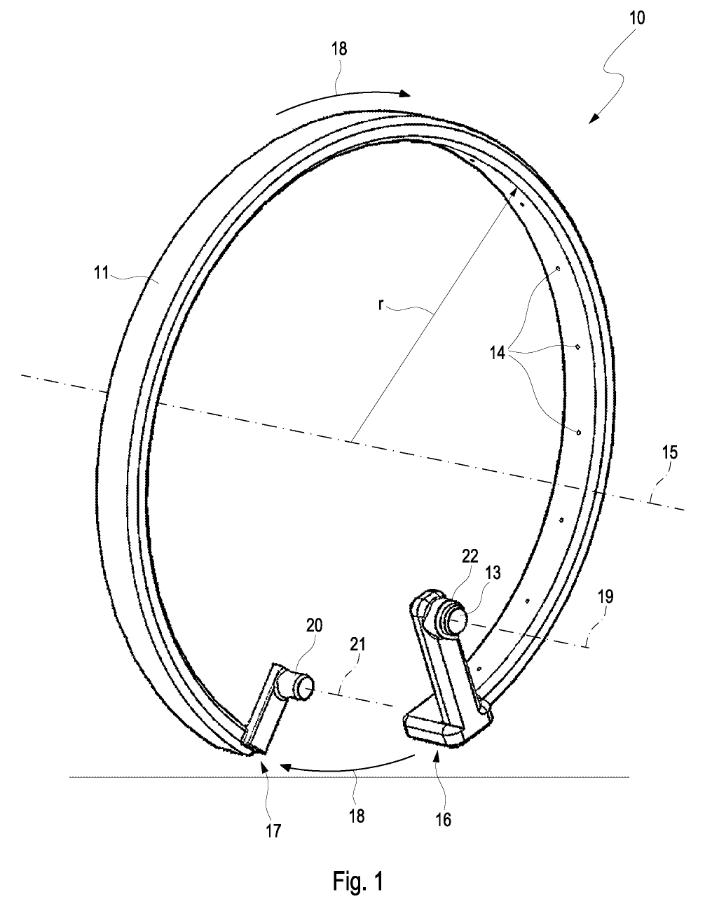

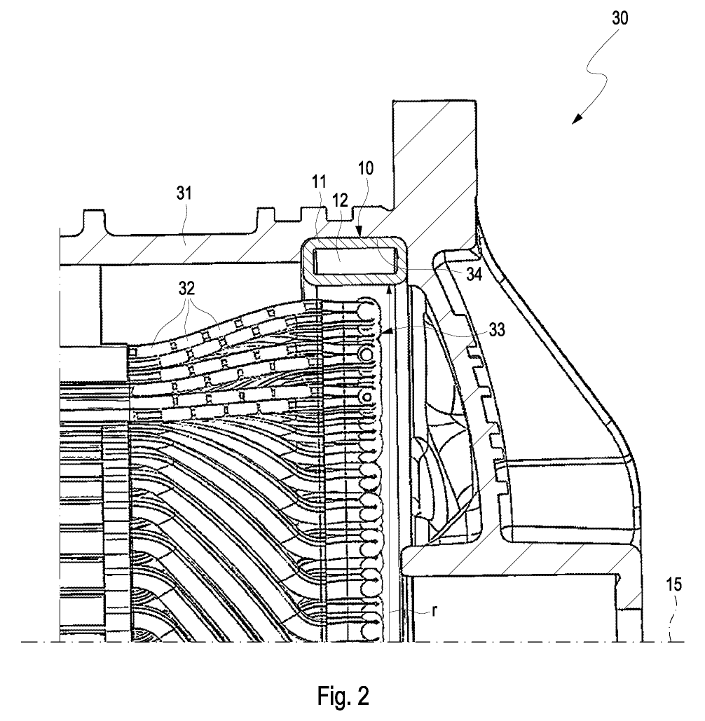

FIG. 1 shows a perspective view of a spray ring 10 for an electric machine, as depicted, for example, in FIG. 2, according to one embodiment of the disclosure. The spray ring 10 may have a fluid-tight spray body 11 with a cavity 12 (see FIG. 2). The cavity 12 may be completely surrounded by the fluid-tight spray body 11. A cooling medium (e.g., oil, air or similar) may be introduced into the spray body 11 via a cooling medium inlet 13 formed on the spray body 11. The cooling medium may be used to cool the stator windings (see FIG. 2) of the electric machine. The cooling medium may be discharged from the spray body 11 via spray openings 14 formed on the spray body 11, only some of which are provided with the reference sign 14 in FIG. 1. Said spray openings may be arranged and aligned on the spray body 11 in such a way that the spray openings spray the cooling medium evenly onto the stator windings during operation of the electric machine.

In FIG. 1, it can be seen that the spray body 11 may be formed in an arcuate manner about a body center axis 15, which in the present case is an axis of symmetry or rotation of the spray body 11, and may have a first free end 16 and a second free end 17. The first free end 16 and the second free end 17 may be spaced apart from one another in a circumferential direction 18 of the arcuate spray body 11. The spray body 11 may be elastically deformable in the circumferential direction 18. The spray body 11 may, for example, be made of an elastically deformable plastic material, without however being necessarily limited to this. The spacing of the first and second free ends 16 and 17 and the elastic deformability in the circumferential direction 18 make it possible to temporarily reduce a diameter or radius R of the spray body 11, which may be advantageously used when mounting the spray ring 10 on the electric machine.

In FIG. 1, it can also be seen that the cooling medium inlet 13 in the present exemplary spray ring 10 may be formed as an inlet nozzle which may have a longitudinal nozzle axis 19 that extends substantially parallel to the body axis 15 of the spray body 11, without however being necessarily limited to this. Other geometries and directions of extension are also conceivable.

Furthermore, the coolant inlet 13 of the depicted spray ring 10 may be formed at the first free end 16. However, it is also conceivable that the coolant inlet 13 may be arranged in a curved section of the spray body 11 extending between the first free end 16 and the second free end 17 (not depicted). In the present case, the coolant inlet 13 or inlet nozzle is an integral part of the spray body 11.

Furthermore, a locking pin 20 may be formed at the second free end 17 of the spray ring 10 shown, which may have a longitudinal pin axis 21 that extends substantially parallel to the body axis 15 of the spray body 11. In the present case, the locking pin 20 is an integral part of the spray body 11.

FIG. 1 further indicates that the cooling medium inlet 13 of the spray body 11 may be sealed with respect to a, not depicted, transfer point of the cooling medium, for example in a stator housing of the electric machine, with an O-ring 22, in particular a single O-ring 22.

FIG. 2 shows a longitudinal sectional view through a part of an electric machine 30 according to an embodiment of the disclosure. The electric machine 30 may have a stator housing 31 in which stator windings 32 may be arranged, only some of which are provided with the reference sign 32 in FIG. 2. FIG. 2 shows that the stator windings 32 may form winding heads 33 in an axial end section of the stator housing 31. In the present case, a spray ring according to an embodiment of the disclosure disclosed herein, e.g., the spray ring 10 shown in FIG. 1, is arranged in this axial end section for spraying a cooling medium (e.g., oil, air or the like) onto the stator windings 32 or the winding heads 33 in order to cool them in a manner known per se during operation of the electric machine 30.

In FIG. 2, it can be seen that the stator housing 31 may have a groove 34 extending along the inside of the housing, in which the spray ring 10 may be held.

The cavity 12 of the spray body 11 of the spray ring 10 arranged in the electric machine 30 may have a substantially rectangular cross-section as in the present example.

German patent application no. 102025103374.9, filed January 30, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A spray ring for an electric machine having stator windings, the spray ring comprising:
a fluid-tight spray body having a cavity, a cooling medium inlet formed on the spay body which is configured to receive a cooling medium into the spray body for cooling the stator windings of the electric machine, and spray openings formed on the spray body which are configured to discharge the cooling medium from the spray body,
wherein the spray body is formed in an arcuate manner about a body center axis and has a first free end and a second free end which are spaced apart from one another in a circumferential direction of the arcuate spray body, and
wherein the spray body is elastically deformable in the circumferential direction.

2. The spray ring according to claim 1, wherein the cooling medium inlet is formed as an inlet nozzle which has a longitudinal nozzle axis which extends substantially parallel to the body axis of the spray body.

3. The spray ring according to claim 1, wherein the coolant inlet is formed at the first free end.

4. The spray ring according to claim 1, wherein a locking pin is formed at the second free end, the locking pin having a longitudinal pin axis which extends substantially parallel to the body axis of the spray body.

5. The spray ring according to claim 1, wherein the spray body is formed from an elastically deformable plastic material.

6. The spray ring according to claim 1, wherein the spray body has a single cooling medium inlet.

7. An electric machine comprising a spray ring according to claim 1 and having stator windings which are arranged in a stator housing and form winding heads in an axial end section of the stator housing,
wherein the spray ring is arranged in the axial end section of the stator housing for spraying a cooling medium onto the stator windings and winding heads in order to cool them during operation of the electric machine.

8. The electric machine according to claim 7, wherein the stator housing has a groove extending on an inside of the housing, in which the spray ring is held.

9. The electric machine according to claim 7, wherein the cooling medium inlet of the spray body is sealed with respect to a transfer point of the cooling medium in the stator housing via an O-ring.

10. The electric machine according to claim 9, wherein the cooling medium inlet of the spray body is sealed with respect to a transfer point of the cooling medium in the stator housing via a single O-ring.
